(19) United States
(12) Patent Application Publication
(10) Pub. No.: US 2012/0203569 A1
(43) Pub. Date: Aug. 9, 2012

(54) NOTIFICATION MANAGEMENT METHOD AND SYSTEM

(76) Inventors: Jerald Altman, Paradise Valley, AZ (US); Brent Serio, El Mirage, AZ (US)

(21) Appl. No.: 13/021,304

(22) Filed: Feb. 4, 2011

(51) Int. Cl. G06Q 50/00; G06Q 10/00

(52) U.S. Cl. 705/3; 705/2

(57) ABSTRACT

Methods and systems to enable automated messaging to patients based upon healthcare data are disclosed. The system integrates practice management and electronic health record data, along with patient profile and preference information in order to provide timely notices to the patient. Messaging is provided in a variety of formats and includes the ability to send a message via an email gateway that is delivered to the patient as a text message.

### FIELD OF INVENTION

The present disclosure generally relates to enabling professional practice management by acquiring, analyzing, scheduling and sending notifications to intended recipients.

### BACKGROUND

Companies and service providers (such as professional practices) often attempt to enhance customer satisfaction, increase customer loyalty and drive increased revenue opportunities by contacting customers through a variety of communication. Furthermore, depending upon the industry, type of good, or type of service, providing notifications to a customer may be governed by rule, regulation or law. Professional practices (such as a medical practice) often desire a low cost method of keeping in contact with customers, while integrating complex scheduling customer and practice related information.

Thus, a long-felt need exists to provide a robust, rules driven, sophisticated and customizable messaging system to enable automated messaging to the customers.

### SUMMARY OF THE INVENTION

The present disclosure provides a message scheduling, creation and delivery system. In one embodiment, the system is configured to enable a professional practice (e.g. a medical practice) to send timely and informative messages to their customers (e.g. patients). More specifically, a computer implemented practice management system obtains health information. The health information may be obtained, for example, from registration, practice management, or electronic medical record database. The computer determines, based upon a schedule and the health information, that a recipient should receive a notification. The computer determines recipient information based upon the health information and configures a message comprising the notification. The computer sends the message to a service provider gateway, and the service provider gateway sends the message to the recipient.

### BRIEF DESCRIPTION OF THE DRAWINGS

A more complete understanding of the present inventions may be derived by referring to the detailed description and claims when considered in connection with the Figures, wherein like reference numbers refer to similar elements throughout the Figures, and:

FIG. 1 is a block diagram illustrating major system components for a practice management messaging system, in accordance with an embodiment; and

FIG. 2 is a process flow chart showing a process for automating message scheduling, creation and delivery, in accordance with an embodiment.

### DETAILED DESCRIPTION OF EXEMPLARY EMBODIMENTS

The present disclosure fundamentally changes the way professionals manage communications with their customers. The disclosure improves upon existing systems by providing a tangible, integrated, and automated professional practice management system (“PMMS”). The disclosure may be implemented by a system or a method or any combination of systems and methods. PMMS may allow an administrator to configure a schedule and enable automated messages to customers. In an embodiment, customer (e.g., patient) notifications are sent via an email gateway to a service provider gateway that transforms the messages into text (e.g., short message service) format. Although a medical practice may be used to illustrate some embodiments of the invention, one skilled in the art will recognize that, in various embodiments, the system components, rules, processes, programs and may vary to provide enhanced features or functionality for any type of business or professional practice. PMMS functionality enables messaging, communication and data sharing aspects of a social network or online community. For instance, a parent (or other authorized person) may receive messages on a social network and custom rules may be used to determine which types of messages should be delivered.

The detailed description of exemplary embodiments herein makes reference to the accompanying drawings, which show the exemplary embodiments by way of illustration and their best mode. While these exemplary embodiments are described in sufficient detail to enable those skilled in the art to practice the disclosure, it should be understood that other embodiments may be realized and that logical and mechanical changes may be made without departing from the spirit and scope of the disclosure. Thus, the detailed description herein is presented for purposes of illustration only and not of limitation. For example, the steps recited in any of the method or process descriptions may be executed in any order and are not limited to the order presented. Moreover, any of the functions or steps may be outsourced to or performed by one or more third parties. Furthermore, any reference to singular includes plural embodiments, and any reference to more than one component may include a singular embodiment.

While the embodiments described herein are described in sufficient detail to enable those skilled in the art to practice the invention, it should be understood that other embodiments may be realized and that logical and mechanical changes may be made without departing from the spirit and scope of the invention. Thus, the detailed description herein is presented for purposes of illustration only and not of limitation.

For the sake of brevity, conventional data networking, application development and other functional aspects of the systems (and components of the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical system.

In one embodiment, PMMS includes a user interface (UI), a software module, logic engines, numerous databases and computer networks. While PMMS may contemplate upgrades or reconfigurations of existing processing systems, changes to existing databases and system components are not necessarily required by the present invention.

The benefits provided by this disclosure include, for example, increased efficiency, increased customer satisfaction, increase patient attendance at scheduled appointments, increase compliance with government regulations, and increased reliability and functionality in managing communications.

While the description references specific technologies, system architectures and data management techniques, practitioners will appreciate that this description is but one embodiment and that other devices and/or methods may be implemented without departing from the scope of the invention. Similarly, while the description references a user interfacing with the system via a personal computer user interface, practitioners will appreciate that other interfaces may include mobile devices, kiosks and handheld devices such as mobile phones, smart phones, tablet computing devices, etc.

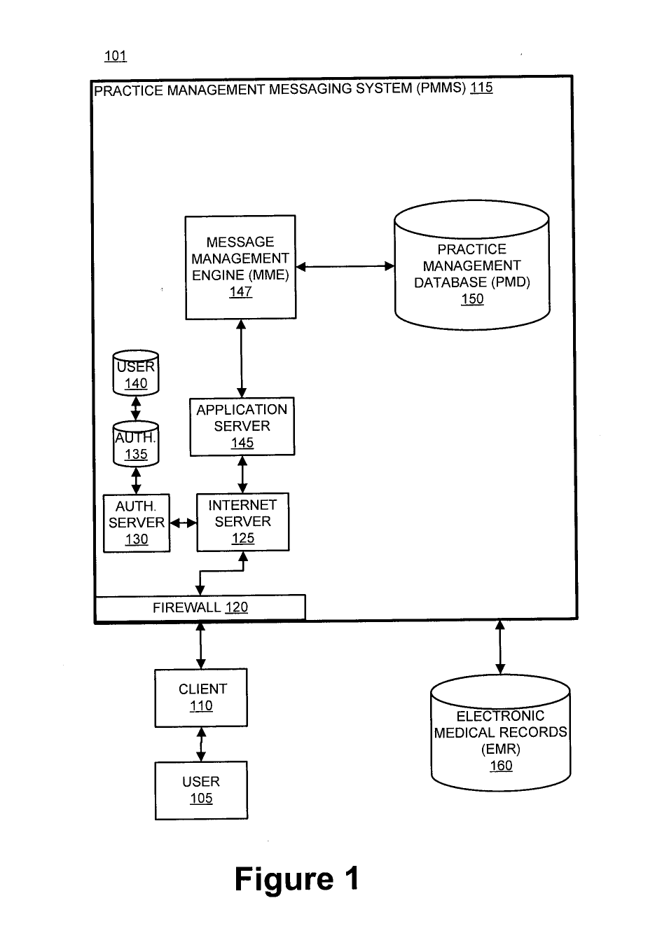

A “user” may include any individual, entity, software and/or hardware that interacts with a system and/or participates in a process. With reference to FIG. 1, user 105 may perform tasks such as configuring a schedule, entering customer information, receiving a communication, and requesting, retrieving, receiving, updating, analyzing and/or modifying data. User 105 may interface with Internet server 125 via any communication protocol, device or method discussed herein, known in the art, or later developed. User 105 may be, for example, an office manager, system administrator, customer, patient, recipient, medical professional, legal professional, etc.

In one embodiment, with reference to FIG. 1, system 101 includes a user 105 interfacing with a PMMS 115 by way of a client 110. PMMS 115 is a fully integrated system comprised of various subsystems, modules and databases. Client 110 comprises any hardware and/or software suitably configured to facilitate entering, accessing, requesting, retrieving, updating, analyzing, entering and/or modifying data. The data may include communication data (e.g. email, audio, video, text, graphics, files, etc), verification data, authentication data, schedule data, healthcare information, prescription drug data, account data, general ledger data, transaction data, or any information discussed herein.

Client 110 includes any device (e.g., computer), which communicates (in any manner discussed herein) with the PMMS 115 via any network discussed herein. Browser applications comprise Internet browsing software installed within a computing unit or system to conduct online communications and transactions. These computing units or systems may take the form of personal computers, mobile phones, personal digital assistants, mobile email devices, laptops, notebooks, hand held computers, portable computers, kiosks, and/or the like. Practitioners will appreciate that the client 110 may or may not be in direct contact with the PMMS 115. For example, the client 110 may access the services of the PMMS 115 through another server, which may have a direct or indirect connection to Internet server 125.

User 105 may communicate with the PMMS 115 through a firewall 120 to help ensure the integrity of the PMMS 115 components. Internet server 125 may include any hardware and/or software suitably configured to facilitate communications between the client 110 and one or more PMMS 115 components.

Firewall 120, as used herein, may comprise any hardware and/or software suitably configured to protect PMMS 115 components from users of other networks. Firewall 120 may reside in varying configurations including stateful inspection, proxy based and packet filtering, among others. Firewall 120 may be integrated as software within Internet server 125, any other system 101 component, or may reside within another computing device or may take the form of a standalone hardware component.

Authentication server 130 may include any hardware and/or software suitably configured to receive authentication credentials, encrypt and decrypt credentials, authenticate credentials, and/or grant access rights according to pre-defined privileges associated with the credentials. Authentication server 130 may grant varying degrees of application and data level access to users based on information stored within authentication database 135 and user database 140. Application server 145 may include any hardware and/or software suitably configured to serve applications and data to a connected client 110.

According to one embodiment, PMMS 115 is used to obtain a variety of information regarding a customer, products, services, events, and factors that may be helpful in determining a notification schedule, formulating a notification and/or configuring a message for distribution via a service provider (e.g. a wireless telecommunications company). PMMS 115 is a fully integrated system comprised of various subsystems, modules and databases. With reference again to FIG. 1, PMMS 115 allows communication with a practice management database (“PMD”) 150 and various other portals and UIs (not shown in FIG. 1). In one embodiment, UIs are accessed via a web portal to process registration information, enable administration tasks (e.g., account maintenance and input), configure security and other settings for interconnection with industry service providers, send and receive email messages, text messages (e.g., SMS), multimedia messaging service (MMS) messages and the like. PMMS 115 components are interconnected and communicate with one another to allow for a completely integrated notification management system that allows organizations, for example, to automate reminder messages and other notifications, send and receive email and text communications, review data and records, manage schedules (e.g. patient appointments), approve/disapprove messaging content, etc.

Message management engine (“MME”) 147 is a software module configured to enable online functions such as obtaining data from third-party data sources, configuring messages, scheduling notifications, analyzing event information, updating schedules based upon criteria and events, storing, editing and updating business rules, receiving query requests, configuring responses, dynamically configuring user interfaces, requesting data, receiving data, displaying data, prompting user 105 with security challenges, verifying user responses, authenticating the user, initiating PMMS 115 processes, initiating other software modules, encrypting and decrypting. Additionally, MME 147 may include any hardware and/or software suitably configured to receive requests from client 110 via Internet server 125 and application server 145. MME 147 is further configured to process requests, execute transactions, construct database queries, and/or execute queries against databases, within system 101 (e.g., PMD 150), external data sources and temporary databases. In one embodiment, MME 147 is configured to execute application programming interfaces in order to communicate with a variety of messaging platforms such as, for instance, email systems, wireless communications systems, mobile communications systems, MMS systems/gateways, SMS systems/gateways, smart mixed-signal connectivity (SMSC) gateways, and the like. For example, in one embodiment, MME 147 is configured to interface with a Mobile Number Portability (MNP) service (also known as “IMSI-lookup”, “Network Look up Service” or “HLR Lookup”) or other network query service used to identify Mobile phone networks (e.g., Mobile Station Integrated Services Digital Networks or “MSISDN”) in order to determine proper routing of a notification message.

MME 147 is configured to exchange data with other systems and application modules. In one embodiment, the MME 147 may be configured to interact with other system 101 components to perform complex calculations, retrieve additional data, format data into reports, create XML representations of data, construct markup language documents, construct, define or control UIs, and/or the like. Moreover, MME 147 may reside as a standalone system or may be incorporated with the application server 145 or any other PMMS 115 component as program code. As one of ordinary skill in the art will appreciate, MME 147 may be logically or physically divided into various subcomponents such as a workflow engine configured to evaluate predefined rules and to automate processes associated with a practice management, patients records, scheduling and/or messaging system and/or a social network in PMMS 115.

In addition to the components described above, PMMS 115 may further include one or more of the following: a host server or other computing systems including a processor for processing digital data; a memory coupled to the processor for storing digital data; an input digitizer coupled to the processor for inputting digital data; an application program stored in the memory and accessible by the processor for directing processing of digital data by the processor; a display device coupled to the processor and memory for displaying information derived from digital data processed by the processor; and a plurality of databases.

As will be appreciated by one of ordinary skill in the art, one or more system 101 components may be embodied as a customization of an existing system, an add-on product, upgraded software, a stand-alone system (e.g., kiosk), a distributed system, a method, a data processing system, a device for data processing, and/or a computer program product. Accordingly, individual system 101 components may take the form of an entirely software embodiment, an entirely hardware embodiment, or an embodiment combining aspects of both software and hardware. Furthermore, individual system 101 components may take the form of a computer program product on a computer-readable storage medium having computer-readable program code means embodied in the storage medium. Any suitable computer-readable storage medium may be utilized, including hard disks, CD-ROM, optical storage devices, magnetic storage devices, and/or the like.

Client 110 may include an operating system (e.g., Windows XP, Windows NT, 95/98/2000, XP, Windows 7, Vista, OS2, UNIX, Linux, Solaris, MacOS, Windows Mobile OS, Windows CE, Palm OS, Symbian OS, Blackberry OS, J2ME, etc.) as well as various conventional support software and drivers typically associated with mobile devices and/or computers. Client 110 may be in any environment with access to any network, including both wireless and wired network connections. In an embodiment, access is through a network or the Internet through a commercially available web-browser software package. Client 110 and PMMS 115 components may be independently, separately or collectively suitably coupled to the network via data links which includes, for example, a connection to an Internet Service Provider (ISP) over the local loop as is typically used in connection with standard wireless communications networks and/or methods, modem communication, cable modem, Dish networks, ISDN, Digital Subscriber Line (DSL), see, e.g., Gilbert Held, Understanding Data Communications (1996). In an embodiment, any portion of client 110 is partially or fully connected to a network using a wired (“hard wire”) connection. As those skilled in the art will appreciate, client 110 and/or any of the system components may include wired and/or wireless portions.

Internet server 125 may be configured to transmit data to client 110 within markup language documents. “Data” may include encompassing information such as commands, messages, transaction requests, queries, files, data for storage, and/or the like in digital or any other form. Internet server 125 may operate as a single entity in a single geographic location or as separate computing components located together or in separate geographic locations. Further, Internet server 125 may provide a suitable web site or other Internet-based graphical user interface, which is accessible by users. In one embodiment, the Microsoft Internet Information Server (IIS), Microsoft Transaction Server (MTS), and Microsoft SQL Server, are used in conjunction with the Microsoft operating system, Microsoft NT web server software, a Microsoft SQL Server database system, and a Microsoft Commerce Server. In one embodiment, Linux, Apache, Informix MySQL and PHP hypertext processor are used to enable PMMS 115. Additionally, components such as Access or Microsoft SQL Server, Oracle, Sybase, InterBase, etc., may be used to provide an Active Data Object (ADO) compliant database management system.

Like Internet server 125, application server 145 may communicate with any number of other servers, databases and/or components through any means known in the art. Further, application server 145 may serve as a conduit between client 110 and the various systems and components of PMMS 115. Internet server 125 may interface with application server 145 through any means known in the art including a LAN/WAN, for example. Application server 145 may further invoke software modules such as the MME 147, automatically or in response to user 105 requests.

Any of the communications, inputs, storage, databases or displays discussed herein may be facilitated through a web site having web pages. The term “web page” as it is used herein is not meant to limit the type of documents and applications that may be used to interact with the user. For example, a typical web site may include, in addition to standard HTML documents, various forms, Java applets, JavaScript, active server pages (ASP), common gateway interface scripts (CGI), Flash files or modules, FLEX, ActionScript, extensible markup language (XML), dynamic HTML, cascading style sheets (CSS), helper applications, plug-ins, and/or the like. A server may include a web service that receives a request from a web server, the request including a URL (e.g., http://yahoo.com/) and an interne protocol (“IP”) address. The web server retrieves the appropriate web pages and sends the data or applications for the web pages to the IP address. Web services are applications that are capable of interacting with other applications over a communications means, such as the Internet. Web services are typically based on standards or protocols such as XML, SOAP, WSDL and UDDI. Web services methods are well known in the art, and are covered in many standard texts. See, e.g., Alex Nghiem, IT Web Services: A Roadmap for the Enterprise (2003).

FIG. 1 depicts databases that are included in an exemplary embodiment. An exemplary list of various databases used herein includes: an authentication database 135, a user database 140, PMD 150, electronic medical records (“EMR”) 160 and/or other databases that aid in the functioning of the system. As practitioners will appreciate, while depicted as separate and/or independent entities for the purposes of illustration, databases residing within system 101 may represent multiple hardware, software, database, data structure and networking components. Furthermore, embodiments are not limited to the exemplary databases described herein, nor do embodiments necessarily utilize each of the disclosed exemplary databases.

Authentication database 135 may store information used in the authentication process such as, for example, user identifiers, passwords, access privileges, user preferences, user statistics, and the like. User database 140 maintains user information and credentials for PMMS 115 users (e.g., user 105).

PMD 150 is a data repository that is configured to store a wide variety of comprehensive data for PMMS 115. While depicted as a single logical entity in FIG. 1, those of skill in the art will appreciate that PMD 150 may, in some embodiments, consist of multiple physical and/or logical data sources. In one embodiment, PMD 150 stores registration data, customer profile and demographic data, contact information, insurance information, account information, a responsible provider, a provider location, a test result, drug information, an appointment, healthcare rules and regulations, scheduling rules, privacy data, information regarding pricing of goods and services, information regarding related and/or complementary goods and services, appointment history, prescription history, medical history, electronic medical record data, messages, audio, video, configuration data, security profiles, access rules, content analysis rules, audit records, predefined rules, process definitions, financial data, and the like. EMR 160 stores patient medical history, hospital data, rules and regulations, and other medical or health information system data.

Any databases discussed herein may include relational, hierarchical, graphical, or object-oriented structure and/or any other database configurations. Common database products that may be used to implement the databases include DB2 by IBM (Armonk, N.Y.), various database products available from Oracle Corporation (Redwood Shores, Calif.), Microsoft Access or Microsoft SQL Server by Microsoft Corporation (Redmond, Wash.), MySQL by MySQL AB (Uppsala, Sweden), or any other suitable database product. Moreover, the databases may be organized in any suitable manner, for example, as data tables or lookup tables. Each record may be a single file, a series of files, a linked series of data fields or any other data structure. Association of certain data may be accomplished through any desired data association technique such as those known or practiced in the art. For example, the association may be accomplished either manually or automatically. Automatic association techniques may include, for example, a database search, a database merge, GREP, AGREP, SQL, using a key field in the tables to speed searches, sequential searches through all the tables and files, sorting records in the file according to a known order to simplify lookup, and/or the like. The association step may be accomplished by a database merge function, for example, using a “key field” in pre-selected databases or data sectors. Various database tuning steps are contemplated to optimize database performance. For example, frequently used files such as indexes may be placed on separate file systems to reduce In/Out (“I/O”) bottlenecks.

One skilled in the art will also appreciate that, for security reasons, any databases, systems, devices, servers or other components of system 101 may consist of any combination thereof at a single location or at multiple locations, wherein each database or system includes any of various suitable security features, such as firewalls, access codes, encryption, decryption, compression, decompression, and/or the like.

The systems and methods may be described herein in terms of functional block components, screen shots, optional selections and various processing steps. It should be appreciated that such functional blocks may be realized by any number of hardware and/or software components configured to perform the specified functions. For example, the system may employ various integrated circuit components, e.g., memory elements, processing elements, logic elements, look-up tables, and the like, which may carry out a variety of functions under the control of one or more microprocessors or other control devices. Similarly, the software elements of the system may be implemented with any programming or scripting language such as C, C++, C#, Java, JavaScript, Flash, ActionScript, FLEX, VBScript, Macromedia Cold Fusion, COBOL, Microsoft Active Server Pages, assembly, PERL, PHP, awk, Python, Visual Basic, SQL Stored Procedures, PL/SQL, any UNIX shell script, and extensible markup language (XML) with the various algorithms being implemented with any combination of data structures, objects, processes, routines or other programming elements. Further, it should be noted that the system may employ any number of conventional techniques for data transmission, signaling, data processing, network control, and the like. Still further, the system could be used to detect or prevent security issues with a client-side scripting language, such as JavaScript, VBScript or the like. For a basic introduction of cryptography and network security, see any of the following references: (1) “Applied Cryptography: Protocols, Algorithms, And Source Code In C,” by Bruce Schneier, published by John Wiley & Sons (second edition, 1995); (2) “Java Cryptography” by Jonathan Knudson, published by O'Reilly & Associates (1998); (3) “Cryptography & Network Security: Principles & Practice” by William Stallings, published by Prentice Hall.

These software elements may be loaded onto a general purpose computer, special purpose computer, or other programmable data processing apparatus to produce a machine, such that the instructions that execute on the computer or other programmable data processing apparatus create means for implementing the functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions. Further, illustrations of the process flows and the descriptions thereof may make reference to user windows, web pages, web sites, web forms, prompts, etc. Practitioners will appreciate that the illustrated steps described herein may comprise in any number of configurations including the use of windows, web pages, web forms, popup windows, prompts and/or the like. It should be further appreciated that the multiple steps as illustrated and described may be combined into single web pages and/or windows but have been expanded for the sake of simplicity. In other cases, steps illustrated and described as single process steps may be separated into multiple web pages and/or windows but have been combined for simplicity.

Referring again to FIG. 1, in one embodiment, when user 105 logs onto an application Internet server 125 may invoke an application server 145. Application server 145 invokes logic in the MME 147 by passing parameters relating to the user's 105 requests for data. PMMS 115 manages requests for data from MME 147 and communicates with system 101 components. Transmissions between user 105 and Internet server 125 may pass through a firewall 120 to help ensure the integrity of PMMS 115 components. Practitioners will appreciate that the invention may incorporate any number of security schemes or none at all. In one embodiment, Internet server 125 receives requests from client 110 and interacts with various other system 101 components to perform tasks related to requests from client 110.

Internet server 125 may invoke an authentication server 130 to verify the identity of user 105 and assign roles, access rights and/or permissions to user 105. In order to control access to the application server 145 or any other component of PMMS 115, Internet server 125 may invoke an authentication server 130 in response to user 105 submissions of authentication credentials received at Internet server 125. When a request to access PMMS 115 is received from Internet server 125, Internet server 125 determines if authentication is required and transmits a prompt to client 110. User 105 enters authentication data at client 110, which transmits the authentication data to Internet server 125. Internet server 125 passes the authentication data to authentication server which queries the user database 140 for corresponding credentials. When user 105 is authenticated, user 105 may access various applications and their corresponding data sources.

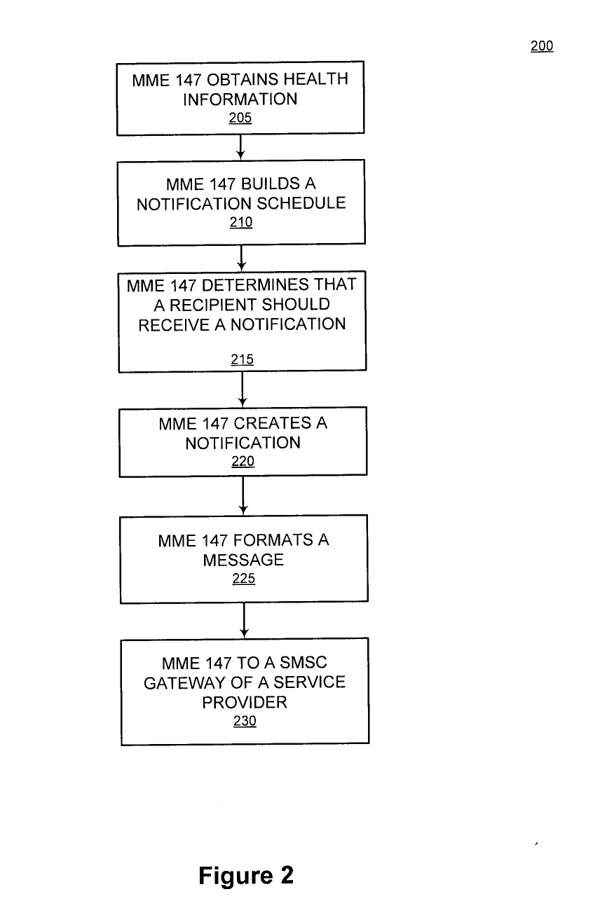

With reference to FIG. 2, in one embodiment, MME 147 executes a process to send notification messages to a customer. For example, PMMS 115 may be implemented by a medical practice to, for example, automate all messaging to patients. Thus, in an embodiment, PMMS 115 executes rules, processes schedules and evaluates patient information in order to determine when a notification should be sent to a patient. PMMS 115 also analyzes patient contact information to determine how (e.g. what format) and where to send notifications. As disclosed previously, PMMS 115 enables configuring, sending, and tracking of a wide variety of electronic messages. While discussed in terms of text or email messaging for purposes of illustration, one of skill in the art will recognize that the processes disclosed may be used to enable access control, monitoring and tracking of any type of electronic or data message (e.g., text, email, social networking messages or content).

In one embodiment, MME 147 executes a computer-based method for professional practice management. MME 147 obtains health information (Step 205). For example, MME may obtain health information from patient registration information that is entered into PMMS 115 and stored in PMD 150 via a registration or patient enrollment application (or service). For example, an enrollment application queries a patient regarding the patients notification preferences (e.g. to allow the patient to opt-in to receiving automated notifications). In one embodiment, MME 147 obtains health information from at least one of a practice management database, an electronic health record database and an electronic medical record database (e.g., EMR 160).

Health information may include patient profiles, demographics, patient history, account information, insurance information, claim information, patient health and medical profile, scheduling history, notification rules, notification history, contact information, a responsible provider, a provider location, a test result, drug information, scheduled appointments, healthcare regulations, privacy notices, related products and services, a patient purchase history, payment account information, prescription history, medical history, and electronic medical record data. In an embodiment, EMR 160 queries a PMD 150 in order to obtain recipient information to access an EMD 160 to acquire patient medical records.

MME 147 builds a notification schedule (Step 210). In an embodiment, MME 147 may include an administration tool (e.g., comprising software modules and user interfaces) that enables a user 105 to build a notification schedule based upon the health information. For example, an office manager at a medical practice (user 105) may receive query results comprising the health information. In an embodiment, query results may are generated automatically by MME 147 and/or a query may be created and executed by user 105 to generate query results. For example, the query may search the database for new patients that have opted to receive automated notifications. In an embodiment, the query is saved as an automated scheduled query that is executed by MME 147 to generate data for notification and to format the notification messages. The query may be executed as part of a scheduled job or may be event driven; that is, the query may be triggered automatically by other data or events. In one embodiment, a notification or confirmation message is sent to a recipient to inform the recipient that schedule notifications have been implemented.

MME 147 determines that a recipient should receive a notification (Step 215). In an embodiment, MME 147 automatically processes notification query results. For example, the query results may be saved as a file on a file system or in a database table and MME 147 accesses the query results, applies business rules and formats notifications. MME 147 determines recipient information. In one embodiment, recipient information from the query results includes a phone number and service provider. The service provider information may include an address (e.g. URL) to a messaging gateway (e.g. SMS gateway).

In one embodiment, MME 147 performs a lookup (e.g. on a telecommunications directory service) to determine the mobile service provider associated with the recipient's phone number. In an embodiment the lookup is performed to find the mobile service provider and then MME 147 associates the correct provider domain name for the message delivery. For example, the contact information indicates that notification messages should be sent to (602)555-1212 and MME 147 a lookup is performed on the phone number to find out the provider code associate with it. MME 147 finds the associated domain (e.g., tmomail.net corresponds to T-Mobile) for the provider code and the message is addressed appropriately (e.g., 6025551212@tmomail.net). In an embodiment, MME 147 store the provider associated with the number in PMD 150 for future use.

MME 147 creates a notification (Step 220). A notification may be, for example, a simple reminder that a scheduled appointment is upcoming, a communication of test results, a notice of a policy change, a notice required by a health regulation, a general health notice (e.g., flu shots are now available), etc. In an embodiment, the frequency and content of a patient notification may be at least partially based upon electronic medical record data. MME formats the notification. In various embodiments, a notification may include text, graphics, video, audio, a file attachment, a downloadable file, etc. In an embodiment, the notification may comprise a link (e.g., a URL); for example notifications that include private sensitive data may be accessible by following the link to a secure patient portal.

MME 147 formats a message (Step 225). The message comprises the notification (e.g., the information that is being communicated) plus the formatting for sending the message to the recipient. As discussed above, MME 147 comprises logic and parameters to determine service provider information and to format messages based upon various service provider specifications. In an embodiment, MME 147 formats an email message and PMMS 115 sends the email message via an email gateway. In an embodiment the message is to be delivered via SMS and the email message is sent by MME 147 to a SMSC gateway of a service provider (Step 230). The SMSC gateway converts the message to SMS format and sends the message to the recipient. In an embodiment, the message is sent to an SMS gateway and/or and email gateway.

In an embodiment, PMMS 115 receives and processes health care events. For example, a recipient may automatically receive a notice when a new drug is approved by the FDA or may receive a notice when a test result is made available. In various embodiments, a healthcare event may include an upcoming appointment, a recommended appointment, a recommendation determined based upon the health information, a provider service offering, a policy change, a new or updated federal regulation, a new or updated state regulation, an insurance coverage change, a claim denial, a prescription refill availability, a prescription reminder and a payment reminder. In an embodiment, PMMS 115 processes healthcare events by sending out a notice (e.g., an event driven notification).

While the steps outlined above represent specific embodiments of the invention, practitioners will appreciate that there are any number of computing algorithms and user interfaces that may be applied to create similar results. The steps are presented for the sake of explanation only and are not intended to limit the scope of the invention in any way. Benefits, other advantages, and solutions to problems have been described herein with regard to specific embodiments. However, the benefits, advantages, solutions to problems, and any element(s) that may cause any benefit, advantage, or solution to occur or become more pronounced are not to be construed as critical, required, or essential features or elements of any or all the claims of the invention.

It should be understood that the detailed description and specific examples, indicating exemplary embodiments of the invention, are given for purposes of illustration only and not as limitations. Many changes and modifications within the scope of the instant invention may be made without departing from the spirit thereof, and the invention includes all such modifications. Corresponding structures, materials, acts, and equivalents of all elements are intended to include any structure, material, or acts for performing the functions in combination with other elements. Reference to an element in the singular is not intended to mean “one and only one” unless explicitly so stated, but rather “one or more.” Moreover, when a phrase similar to “at least one of A, B, or C” or “at least one of A, B, and C” is used in the claims or the specification, the phrase is intended to mean any of the following: (1) at least one of A; (2) at least one of B; (3) at least one of C; (4) at least one of A and at least one of B; (5) at least one of B and at least one of C; (6) at least one of A and at least one of C; or (7) at least one of A, at least one of B, and at least one of C.

1. A computer-generated method for professional practice management comprising:
obtaining, by a computer for managing a professional practice, health information;
determining, by the computer and based upon a schedule and the health information, that a recipient should receive a notification;
determining, by the computer and based upon the health information, recipient information;
creating, by the computer and based upon the recipient information, a message comprising the notification; and
sending, by the computer, the message to a service provider gateway, wherein the service provider gateway sends the message to the recipient.

2. The method of claim 1, wherein the obtaining comprises receiving the health information from at least one of a practice management database, an electronic health record database and an electronic medical record database.

3. The method of claim 1, wherein the recipient information comprises at least one of a recipient demographic, recipient contact information, recipient insurance information, recipient account information, a responsible provider, a provider location, a test result, drug information, an appointment, a healthcare regulation, a privacy notice, account information, a related service, a related product, an appointment history, a prescription history, a medical history, and electronic medical record data.

4. The method of claim 3, wherein the obtaining comprises forming a query based upon the health information, executing the query against a database and receiving results of the query, wherein the database comprises at least one of a practice management database, an electronic health record database and an electronic medical record database.

5. The method of claim 4, wherein the receiving the results of the query comprises storing the results in a non-transitory memory.

6. The method of claim 4, further comprising creating the schedule based upon the results.

7. The method of claim 6, further comprising creating at least one of a scheduled job and a scheduled query based upon the schedule.

8. The method of claim 1, wherein the message comprises an email message and the service provider gateway comprises a smart mixed-signal connectivity (SMSC) gateway.

9. The method of claim 1, wherein the service provider gateway comprises a short message service (SMS) gateway.

10. The method of claim 1, further comprising determining, based upon the recipient information, a recipient address and determining, based upon the recipient address, at least one of the service provider gateway and a service provider associated with the service provider gateway.

11. The method of claim 10, further comprising formatting the message based upon the service provider.

12. The method of claim 1, wherein the determining that a recipient should receive a notification comprises determining that the recipient has opted to receive notifications.

13. The method of claim 12, wherein the determining that the recipient has opted to receive notifications comprises at least one of receiving registration information from the recipient and determining an opt-in indicator based upon the health information

14. The method of claim 1, further comprising updating the schedule based upon a health care event.

15. The method of claim 1, wherein the health care event comprises at least one of an upcoming appointment, a recommended appointment, a recommendation determined based upon the health information, a provider service offering, a policy change, a federal regulation, a state regulation, a prescription refill, a prescription reminder and a payment reminder.

16. The method of claim 1, further comprising querying a practice management database and obtaining recipient information necessary to access an electronic medical record.

17. The method of claim 1, wherein the notification poses a question to the recipient and receiving a reply via SMS and updating, based upon the reply, at least one of the recipient information and a practice management database.

18. The method of claim 1, wherein the notification comprises a link to a secure patient portal.

19. A non-transitory computer-readable storage medium having computer-executable instructions stored thereon that, if executed by a computer for managing a professional practice, causes the computer to perform operations comprising:
obtaining, by the computer, health information;
determining, by the computer and based upon a schedule and the health information, that a recipient should receive a notification;
determining, by the computer and based upon the health information, recipient information;
creating, by the computer and based upon the recipient information, a message comprising the notification; and
sending, by the computer, the message to a service provider gateway, wherein the service provider gateway sends the message to the recipient.

20. A system comprising:
a network interface communicating with a non-transitory memory;
the memory communicating with a processor for managing a professional practice; and
the processor, when executing a computer program for managing a professional practice, performs operations comprising:
obtaining, by the processor, health information;
determining, by the processor and based upon a schedule and the health information, that a recipient should receive a notification;
determining, by the processor and based upon the health information, recipient information;
creating, by the processor and based upon the recipient information, a message comprising the notification; and
sending, by the processor, the message to a service provider gateway, wherein the service provider gateway sends the message to the recipient.
